(19) United States
(12) Patent Application Publication
(10) Pub. No.: US 2017/0324353 A1
(43) Pub. Date: Nov. 9, 2017

(54) METHOD FOR MONITORING CHANGE IN CAPACITANCE IN ELECTRIC SYSTEM AND ELECTRIC SYTEM

(71) Applicant: ABB Technology Oy, Helsinki (FI)

(72) Inventors: Tero Viitanen, Vantaa (FI); Jarno Alahuhtala, Espoo (FI); Mikko Saarinen, Helsinki (FI)

(21) Appl. No.: 15/586,057

(22) Filed: May 3, 2017

(30) Foreign Application Priority Data
May 3, 2016 (EP) 16168003.8

(51) Int. Cl. H02M 7/5395; H02M 1/08; H02M 1/084; H02M 1/14

(52) U.S. Cl. CPC H02M 7/5395; H02M 1/14; H02M 1/083; H02M 1/084

(57) ABSTRACT

A method for monitoring a change in a capacitance in an electric system, and an electric system comprising a multilevel inverter and at least two capacitances connected in series between a negative DC pole and a positive DC pole of the inverter, wherein the connection point between the capacitances is connected to one of the at least one middle DC pole of the inverter, and a controller configured to provide by the inverter an AC current component to one of the at least one middle DC pole of the inverter, which AC current component is distributed between the two capacitances connected to the middle DC pole, and monitor resulting AC voltage components in the two capacitances, and determine on the basis of a difference between the monitored AC voltage components a change in at least one of the two capacitances.

### FIELD OF THE INVENTION

The invention relates to a method for monitoring a change in a capacitance in an electric system, and to an electric system.

### BACKGROUND OF THE INVENTION

An inverter is an electric device enabling conversion of DC (direct current) power from a DC power source to AC (alternating current) power. Herein term ‘inverter’ generally refers to an electric device or circuitry that is able to convert direct current to alternating current. An example of an inverter is a semiconductor bridge implemented by means of controllable semiconductor switches, such as IGBTs (Insulated-gate Bipolar Transistor) or FETs (Field-Effect Transistor), which are controlled according to a modulation or control scheme used.

Multi-level converters, such as inverters or rectifiers, have three DC poles. In addition to positive and negative DC poles, they have at least one middle DC pole at an electric potential between the positive DC pole and the negative DC pole. For example, a three-level converter has three DC poles; a positive DC pole, a negative DC pole, and one middle DC pole (a neutral DC pole). Examples of three-level converters are given in document: T. Brückner, S. Bernet and H. Güldner, “The Active NPC Converter and Its Loss-Balancing Control”, IEEE Transactions on Industrial Electronics, Vol. 52, No. 3, June 2005. In particular, examples of three-level neutral-point-clamped (NPC) converters and active neutral-point-clamped (ANPC) converters are given.

In use there is typically a series connection of capacitances connected between the negative DC pole and the positive DC pole of the multi-level converter such that each connection point between the capacitances is connected to one middle DC pole of the multi-level converter. For example, as illustrated in the example of FIG. 1 showing a three-level inverter, there is a series connection of two capacitances C1, C2 between the negative DC pole dc− and the positive DC pole dc+, wherein the connection point between the two capacitances is connected to the middle DC pole NP of the inverter. The use of N capacitances thus provides N−1 middle DC potentials into which an AC output can be connected. As a result, the total number of available DC potentials will be N+1. Such a multi-level topology enables a better output AC voltage quality as the ripple of the output AC voltage produced can be reduced, for example.

The capacitances connected to the DC input of the inverter may start to decrease over time. For example, a common type of capacitor used is a film capacitor, in which the capacitance thereof tends to decrease over time as a result of the capacitor's self-healing process. In the self-healing process a conductor metallized on the surface of an insulating film vaporizes as a result of partial discharges through the insulation. The self-healing process produces detrimental hydrogen gases which may cause a danger of explosion upon build-up thereof. The capacitances may also decrease as a result of corona, which may be emphasized by moisture being absorbed to the insulation of the capacitor.

A problem related to the possible decrease of the capacitances over time is that if it is not monitored then the control dynamics of the inverter may suffer over time and there may also be a risk of explosion. The capacitances could be monitored by manually measuring them periodically. In practice, such a solution would be burdensome and costly.

### BRIEF DESCRIPTION OF THE INVENTION

An object of the invention is to provide a method and an apparatus for implementing the method so as to solve or at least alleviate the above problems. The object of the invention is achieved by a method, a computer program product, and an electric system that are characterised by what is stated in the independent claims. Preferred embodiments of the invention are described in the dependent claims.

The invention is based on an idea of providing by an inverter an AC current component to at least one middle DC pole of the inverter, which AC current component is distributed between two capacitances connected to the middle DC pole in question, and monitoring the resulting AC voltage components in each of the two capacitances, and then determining on the basis of a difference between the monitored AC voltage components a change in at least one of the two capacitances.

The solution of the invention provides the advantage that the capacitances connected to the DC input of the inverter can be easily monitored. In addition, the invention may be implemented by using existing system elements and hence any additional measuring devices are not necessarily needed.

### BRIEF DESCRIPTION OF THE FIGURES

The invention will now be explained in greater detail in connection with preferred embodiments and with reference to the attached drawings, in which:

FIG. 1 shows an example of an electric system according to an embodiment; and

FIG. 2 shows a voltage diagram according to an embodiment.

### DETAILED DESCRIPTION OF THE INVENTION

The application of the invention is not restricted to any specific system, but it may be applied to various electric systems comprising an inverter and capacitances connected to the DC input thereof. In addition, the use of the invention is not restricted to any specific basic frequency of the system or to any specific voltage level. While the following examples relate to a three-level inverter, the embodiments may be applied to any multi-level inverter.

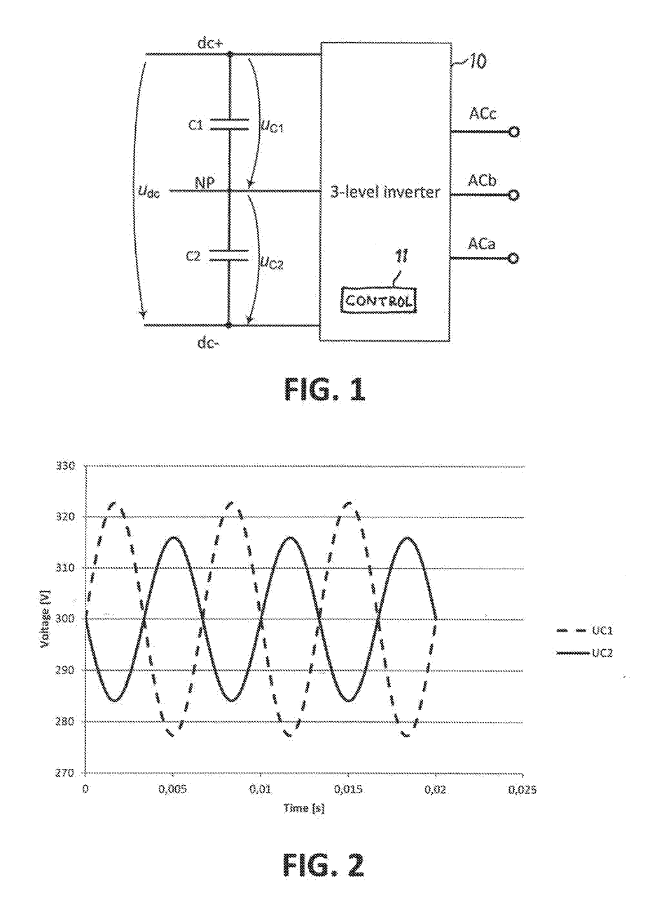

FIG. 1 shows an example of a main circuit of an electric system according to an embodiment. The number of various components may vary from that shown in the figure. The exemplary electric system comprises a three-phase three-level inverter 10, such as an NPC or ANPC inverter, having a DC input dc+, NP, dc−, and an AC output ACa, ACb, ACc. The inverter 10 could alternatively have only one phase, or more than three phases, for example. The exemplary electric system further comprises two capacitances C1, C2 connected in series between the negative DC pole dc− of the inverter and the positive DC pole dc+ of the inverter, wherein the connection point between the two capacitances is connected to the middle DC pole NP of the inverter. The total voltage u_{dc} of the DC input is a sum of the voltages u_{c1}, u_{c2} of the capacitances C1, C2, respectively. Each of the capacitances C1, C2 can comprise one or more capacitors. In case of more than one middle DC poles, the number of capacitances would be higher correspondingly. For example, a series connection of N capacitances could be used when there are N−1 middle DC poles in the inverter such that each connection point between two capacitances of the series connection is connected to a respective middle DC pole. Although the capacitances C1, C2 have been illustrated separate from the inverter 10, it is also possible that the capacitances C1, C2 are physically located inside the inverter 10, or that the capacitances C1, C2 and the inverter are located within a common housing, for example. The inverter 10 may be further connected to a DC supply via its DC input dc+, NP, dc−, and to other AC systems such as AC networks or AC loads via its AC output ACa, ACb, ACc. For the sake of clarity, these are not shown in the figure.

FIG. 1 further shows a control arrangement 11 of the inverter 10 which can control the operation of the inverter 10. The control arrangement 11 may further perform measurements of or receive input signals regarding various quantities, such as current or voltage quantities, in order to perform the control of the inverter 10, for example. Possible measuring arrangements for such quantities are not shown in the figure for the sake of clarity. The control arrangement 11 of the inverter 10 can be used for implementing the functionality according to the various embodiments described herein. Alternatively, it would be possible to use a control arrangement separate from the inverter 10. For example, it would be possible to use additional or separate logical or physical units (not shown) for performing the control functionality of the various embodiments. The functionality of the various embodiments could, for example, be implemented using a separate logic arrangement, which could be at least partly independent of the normal control of the inverter 10, for example.

According to an embodiment, the monitoring of a change in a capacitance in the electric system comprises providing by the inverter 10 an AC voltage to the AC output ACa, ACb, ACc of the inverter from a DC voltage supplied to the DC input dc+, NP, dc− of the inverter 10. This may be part of the normal operation of the inverter 10 and include supplying AC power from the AC output to a load or an AC network, for example. Then, while the AC voltage is provided to the AC output of the inverter, an AC current component is provided by the inverter 10 to one of the at least one middle DC pole NP of the inverter 10, which AC current component is distributed between the two capacitances C1, C2 connected to the middle DC pole NP in question, and resulting AC voltage components in each of the two capacitances C1, C2 are monitored. The AC current component provided may be essentially of a predetermined or known frequency, for example. In other words, an AC current component is supplied by the inverter 10 through the middle DC pole NP such that the AC current component is divided between the two capacitances C1, C2. The AC current component is preferably divided essentially evenly between the two capacitances C1, C2. In this case, however, an instantaneous current component observed at a given time point is not necessarily evenly divided between the two capacitances C1, C2 but, instead, the current component observed over a period of time (e.g. an average of the current component) may be evenly distributed between the two capacitances C1, C2. Finally, a change in at least one of the two capacitances can be determined on the basis of a difference between the monitored AC voltage components in each of the two capacitances C1, C2. According to an embodiment, the change in the at least one of the two capacitances (C1, C2) can be determined by comparing the difference between the monitored AC voltage components to a predetermined threshold value or to a previously obtained difference value. Based on the comparison it can be determined that a change has taken place or a (relative or absolute) magnitude of the change can be determined, for example.

Thus, according to an aspect, the idea is to cause unbalance to the voltages of the capacitances C1, C2 from which a mutual magnitude of the capacitances and possible changes thereof can be determined. The unbalance can be caused with the AC current component provided by the inverter 10 to the at least one middle DC pole NP of the inverter. For example, if the resulting AC voltage components in each of the two capacitances C1, C2 differ from each other, the mutual magnitudes of the capacitances C1, C2 can be compared. Generally, a smaller capacitance has a larger voltage variation. As a result, a difference in the magnitudes of the resulting AC voltage components in the capacitances C1, C2 indicates that the magnitudes of the capacitances are different. If the capacitances C1, C2 are originally of the same value, as is typically the case, then a difference in the magnitudes of the resulting AC voltage components in the capacitances C1, C2 indicates a change in at least one of the capacitances from its original value. In a similar manner, if a difference in the magnitudes of the resulting AC voltage components in the capacitances C1, C2 is higher than a previously determined difference, this indicates a change in at least one of the capacitances from its previous value, for example. FIG. 2 shows a voltage diagram according to an embodiment. In FIG. 2 the resulting AC voltage components UC1, UC2 in each of the two capacitances C1, C2 are shown in a case where the magnitude of capacitance C1 is smaller than the magnitude of capacitance C2.

According to an embodiment, the inverter 10 is pulse width modulation (PWM) controlled according to a voltage reference and the AC current component is provided by including a predetermined zero sequence component (or common mode component) in the voltage reference or modulation reference of the inverter. When such a zero sequence component is implemented in a symmetrical manner, then also the resulting voltage deviation should be essentially symmetrical in both of the two capacitances C1, C2. If this is not the case, then it can be determined that the capacitances are of a different magnitude, for example. The adding of the zero sequence component typically causes short current pulses in the two capacitances C1, C2 due to the PWM. These current pulses in the two capacitances C1, C2 may circulate in the two capacitances C1, C2 simultaneously or non-simultaneously, as the case may be, and hence their instantaneous values may differ at a given time point. These current pulses then in turn cause a lower frequency current component which, on average, may be essentially evenly distributed between the capacitances C1, C2. As an example, when the inverter 10 is a three-level three-phase inverter having one middle DC pole NP, and the electric system comprises a first capacitance C1 connected between the positive DC pole of the inverter and the middle DC pole of the inverter and a second capacitance C2 connected between the middle DC pole of the inverter and the negative DC pole of the inverter, as shown in the example of FIG. 1, the predetermined zero sequence component may comprise a third harmonic, or a multiple thereof, having a predetermined amplitude and phase difference with respect to a fundamental AC voltage. In this case the added harmonic causes an AC voltage component of the same frequency to both of the capacitances C1, C2. And, because the added harmonic and the resulting phase currents are symmetrical, a difference, if any, in the magnitudes of the voltages will indicate that there is a difference in the magnitudes of the capacitances. According to an embodiment, such adding of the third harmonic U₃ (or a multiple thereof) to the fundamental frequency voltage reference U₁ of the inverter may be implemented by using a modified voltage reference U_{mod}=U₁+U₃ in the inverter 10, where:
U₁=a*sin(ωt), and
U₃=Amp3*sin(3ω+Phi3), where
a=amplitude of the voltage reference,
ω=angular velocity,
t=time
Amp3=amplitude of the third harmonic, and
Phi3=phase difference of the third harmonic.

According to an embodiment, the determination of the change in the at least one of the two capacitances C1, C2 on the basis of a difference between the monitored resulting AC voltage components in each of the two capacitances C1, C2 may comprise comparing the magnitudes of the monitored AC voltage components in the two capacitances C1, C2, to each other in order to obtain a difference between the magnitudes of the monitored AC voltage components. In that case the magnitude of the AC voltage components may be peak-to-peak values, maximum values, minimum values or average values, for example. The voltages of the capacitances C1, C2 typically comprise an essentially constant DC component, which is typically approximately equal in the two capacitances, and a negligible PWM frequency AC component. The frequency of the PWM frequency AC component is higher than the frequency of the AC current component provided to the capacitances and hence it may be preferable to filter the measured AC voltages of the capacitances when performing the monitoring of the resulting AC voltage components in the capacitances C1, C2. Thus, the magnitudes of the monitored AC voltage components may be filtered peak-to-peak values over a predetermined period of time, for example. Generally the obtained difference between the magnitudes of the monitored AC voltage components in the two capacitances C1, C2 is proportional to the difference of the magnitudes of the capacitances and hence may be used to detect a change in at least one of the two capacitances. The obtained difference between the magnitudes of the monitored AC voltage components in the two capacitances C1, C2 may be used to update a corresponding parameter or parameters used in the inverter control, for example. Alternatively or additionally, it may be used to monitor the condition of the at least one capacitance according to a predetermined life cycle curve provided by the component manufacturer or according to predetermined typical operating point quantities, for example. For example, if the obtained difference between the magnitudes of the monitored AC voltage components in the two capacitances C1, C2 is higher than a predetermined threshold or a previously obtained difference value, it may be concluded that the condition of the at least one capacitance has changed notably or significantly. It is then possible to create a notification or an alarm to a user of the system and/or trigger automatic safety procedures, such as stopping the inverter, for example.

According to an embodiment, if the inverter 10 has more than one middle DC pole then the providing of the AC current component and the determining of a change in the at least one of the two capacitances are performed for each middle DC pole and the respective capacitances connected thereto. Moreover, according to an embodiment, the determination of a change in the at least one capacitance according to any of the embodiments described herein may be performed at predetermined intervals or continuously, when the inverter 10 is in operation, for example. Also, the AC current component provided to the at least one middle DC pole of the inverter may be provided solely for the purpose of determining a change in the at least one of the two capacitances or such AC current component may result from the normal operation of the inverter 10.

The control arrangement 11 and/or a possible separate control arrangement can be implemented as one unit or as two or more separate units that are configured to implement the functionality of the various embodiments described herein. Here the term ‘unit’ refers generally to a physical or logical entity, such as a physical device or a part thereof or a software routine. The control arrangement 11 according to any one of the embodiments may be implemented at least partly by means of one or more computers or corresponding digital signal processing (DSP) equipment provided with suitable software, for example. Such a computer or digital signal processing equipment preferably comprises at least a working memory (RAM) providing a storage area for arithmetical operations, and a central processing unit (CPU), such as a general-purpose digital signal processor. The CPU may comprise a set of registers, an arithmetic logic unit, and a CPU control unit. The CPU control unit is controlled by a sequence of program instructions transferred to the CPU from the RAM. The CPU control unit may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The computer may also have an operating system which may provide system services to a computer program written with the program instructions. The computer or other apparatus implementing the invention, or a part thereof, may further comprise suitable input means for receiving measurement and/or control data, for example, and output means for outputting control data, for example. It is also possible to use analog circuits, programmable logic devices (PLD), or discrete electric components and devices for implementing the functionality according to any one of the embodiments. For example, the control arrangement 11 according to any one of the embodiments may be implemented at least partly by means of such analog circuits or programmable logic devices.

The invention can be implemented in existing system elements or by using separate dedicated elements or devices in a centralized or distributed manner. Present inverters or generally converter devices, for example, can comprise programmable logic devices, or processors and memory that can be utilized in the functions according to embodiments of the invention. Thus, all modifications and configurations required for implementing an embodiment e.g. in existing inverters may be performed as software routines, which may be implemented as added or updated software routines. If at least part of the functionality of the invention is implemented by software, such software can be provided as a computer program product comprising computer program code which, when run on a computer, causes the computer or a corresponding arrangement to perform the functionality according to the invention as described above. Such a computer program code may be stored or generally embodied on a computer readable medium, such as a suitable memory, a flash memory or an optical memory, for example, from which it is loadable to the unit or units executing the program code. In addition, such a computer program code implementing the invention may be loaded to the unit or units executing the computer program code via a suitable data network, for example, and it may replace or update a possibly existing program code.

It is obvious to a person skilled in the art that, as technology advances, the basic idea of the invention may be implemented in various ways. The invention and its embodiments are thus not restricted to the above examples but may vary within the scope of the claims.

1. A method for monitoring a change in a capacitance in an electric system, the electric system comprising a multilevel inverter having a DC input comprising a positive DC pole, a negative DC pole, and at least one middle DC pole at an electric potential between the positive DC pole and the negative DC pole, and an AC output, and at least two capacitances connected in series between the negative DC pole of the inverter and the positive DC pole of the inverter, wherein the connection point between the at least two capacitances is connected to one of the at least one middle DC pole of the inverter, the method comprising:
a) providing by the inverter an AC voltage to the AC output of the inverter from a DC voltage supplied to the DC input of the inverter;
b) providing by the inverter, while providing the AC voltage to the AC output of the inverter, an AC current component to one of the at least one middle DC pole of the inverter, which AC current component is distributed between the two capacitances connected to the middle DC pole in question, and monitoring resulting AC voltage components in each of the two capacitances; and
c) determining on the basis of a difference between the monitored AC voltage components a change in at least one of the two capacitances.

2. The method of claim 1, wherein in step c) the change in the at least one of the two capacitances is determined by comparing the difference between the monitored AC voltage components to a predetermined threshold value or to a previously obtained difference value.

3. The method of claim 1, wherein the inverter is pulse width modulation controlled according to a voltage reference and wherein the AC current component is provided by including a predetermined zero sequence component to the voltage reference or modulation reference of the inverter.

4. The method of claim 3, wherein the inverter is a three-level three-phase inverter having one middle DC pole and the electric system comprises a first capacitance connected between the positive DC pole of the inverter and the middle DC pole of the inverter, and a second capacitance connected between the middle DC pole of the inverter and the negative DC pole of the inverter, and wherein the predetermined zero sequence component comprises a third harmonic, or a multiple thereof, having a predetermined amplitude and phase difference with respect to a fundamental AC voltage.

5. The method of claim 1, wherein the inverter has more than one middle DC pole and steps b) and c) are performed for each middle DC pole and the respective capacitances connected thereto.

6. The method of claim 1, wherein steps b) and c) are performed continuously during step a) or at predetermined intervals.

7. The method of claim 1, wherein the monitoring of the AC voltage components in the capacitances comprises filtering measured voltage signals.

8. (canceled)

9. An electric system comprising:
a multilevel inverter having a DC input comprising a positive DC pole, a negative DC pole, and at least one middle DC pole at an electric potential between the positive DC pole and the negative DC pole, and an AC output; and
at least two capacitances connected in series between the negative DC pole of the inverter and the positive DC pole of the inverter, wherein the connection point between the at least two capacitances is connected to one of the at least one middle DC pole of the inverter,
wherein the electric system is configured to:
provide by the inverter an AC voltage to the AC output of the inverter from a DC voltage supplied to the DC input of the inverter;
provide by the inverter, while providing the AC voltage to the AC output of the inverter, an AC current component to one of the at least one middle DC pole of the inverter, which AC current component is distributed between the two capacitances connected to the middle DC pole in question, and monitor resulting AC voltage components in each of the two capacitances; and
determine on the basis of a difference between the monitored AC voltage components a change in at least one of the two capacitances.

10. The electric system of claim 9, configured to determine the change in the at least one of the two capacitances by comparing the difference between the monitored AC voltage components to a predetermined threshold value or to a previously obtained difference value.

11. The electric system of claim 9, wherein the inverter is pulse width modulation controlled according to a voltage reference and wherein the electric system is configured to provide the AC current component by including a predetermined zero sequence component to the voltage reference or modulation reference of the inverter.

12. The electric system of claim 11, wherein the inverter is a three-level three-phase inverter having one middle DC pole and the electric system comprises a first capacitance connected between the positive DC pole of the inverter and the middle DC pole of the inverter, and a second capacitance connected between the middle DC pole of the inverter and the negative DC pole of the inverter, and wherein the predetermined zero sequence component comprises a third harmonic, or a multiple thereof, having a predetermined amplitude and phase difference with respect to a fundamental AC voltage.

13. The electric system of claim 9, wherein the inverter has more than one middle DC pole and the electric system is configured to perform the providing of the AC current component and the determining of the change in the at least one of the two capacitances for each middle DC pole and the respective capacitances connected thereto.

14. The electric system of claim 9, configured to perform the providing of the AC current component and the determining of the change in the at least one of the two capacitances continuously during the providing of the AC voltage or at predetermined intervals.

15. The electric system of claim 9, configured to filter measured voltage signals during the monitoring of the AC voltage components in the capacitances.

16. The electric system of claim 9, wherein the inverter is a neutral-point-clamped inverter or an active neutral-point-clamped inverter.

17. An electric system comprising:
a multilevel inverter having a DC input comprising a positive DC pole, a negative DC pole, and at least one middle DC pole at an electric potential between the positive DC pole and the negative DC pole, and an AC output;
at least two capacitances connected in series between the negative DC pole of the inverter and the positive DC pole of the inverter, wherein the connection point between the at least two capacitances is connected to one of the at least one middle DC pole of the inverter; and
a control arrangement comprising a processor and a memory storing instructions that, when executed by the processor, cause the control arrangement to:
control the inverter to provide an AC voltage to the AC output of the inverter from a DC voltage supplied to the DC input of the inverter;
control the inverter to provide, while providing the AC voltage to the AC output of the inverter, an AC current component to one of the at least one middle DC pole of the inverter, which AC current component is distributed between the two capacitances connected to the middle DC pole in question; and monitor resulting AC voltage components in each of the two capacitances; and
determine on the basis of a difference between the monitored AC voltage components a change in at least one of the two capacitances.

18. An inverter controller structured to operate an inverter having a DC input comprising a positive DC pole, a negative DC pole, and at least one middle DC pole at an electric potential between the positive DC pole and the negative DC pole; an AC output; and at least two capacitances connected in series between the negative DC pole of the inverter and the positive DC pole of the inverter, wherein a connection point between the at least two capacitances is connected to one of the at least one middle DC pole of the inverter, the inverter controller comprising:
a processing device; and
a non-transitory computer readable medium structured to store a set of instructions which, when executed by the processing device, operate the inverter so as to:
provide an AC voltage to the AC output of the inverter from a DC voltage supplied to the DC input of the inverter,
provide, while providing the AC voltage to the AC output of the inverter, an AC current component to one of the at least one middle DC pole of the inverter, which AC current component is distributed between the two capacitances connected to the middle DC pole in question, and monitoring resulting AC voltage components in each of the two capacitances, and
determine on the basis of a difference between the monitored AC voltage components a change in at least one of the two capacitances.
